(19) United States
(12) Patent Application Publication
(10) Pub. No.: US 2021/0158293 A1
(43) Pub. Date: May 27, 2021

(54) INFORMATION PROCESSING DEVICE

(71) Applicant: NEITAS PTE. LTD., Singapore (SG)

(72) Inventors: Masataka YOSHIDA, Singapore (SG); Ryuji IMAI, Singapore (SG)

(73) Assignee: NEITAS PTE. LTD., Singapore (SG)

(21) Appl. No.: 16/625,424

(22) PCT Filed: Jun. 22, 2017
(86) PCT No.: PCT/SG2017/050313

§ 371 Date: Dec. 20, 2019

(51) Int. Cl. G06Q 10/10; G06Q 10/06

(52) U.S. Cl. CPC G06Q 10/101; G06Q 10/0633

(57) ABSTRACT

A method is provided in which it is possible to easily perform product development, financing, the acquisition of a manufacturing plant, the acquisition of a component vendor, the acquisition of a sales channel and the like that have so far required a large amount of time and cost. A need reception unit 101 receives, from a need provider who provides need information indicating that it is desired to manufacture a predetermined product, the need information. A design information reception unit 102 discloses the need information and receives design information provided by a participant. A design optimization unit 103 optimizes a design necessary for manufacturing the predetermined product based on the received design information. A manufacturing management unit 104 receives information on a plurality of components of the predetermined product manufactured by the participant based on the details of the optimized design. A flow progress control unit 107 performs control on the flow of the respective processing.

### TECHNICAL FIELD

The present invention relates to information processing devices.

### BACKGROUND ART

Conventionally, a consumer participatory order receiving/placing system has been proposed which processes product planning, order placing, order receiving and the like while checking, in real time, consumers' opinions and reactions on a product to be sold (for example, see patent document 1).
Patent Document 1: Japanese Unexamined Patent Application, Publication No. 2002-163435

### DISCLOSURE OF THE INVENTION

### Problems to be Solved by the Invention

However, in the technology of patent document 1, order receiving/placing operations can simply be performed while referencing, in real time, the results of consumer questionnaires on a product on which a producer or a retailer attempts to receive or place an order. Hence, in conventional technologies including patent document 1, a large number of people cannot participate in the development of a product itself on their own initiative.

The present invention is made in view of the foregoing conditions, and has an object to provide a method in which an aggregation of a plurality of users develops one product in cooperation, and in which thus it is possible to easily perform product development, financing, the acquisition of a manufacturing plant, the acquisition of a component vendor, the acquisition of a sales channel and the like that have so far required a large amount of time and cost.

### Means for Solving the Problems

In order to achieve the above object, as an information processing device according to one aspect of the present invention, an information processing device which manufactures and sells a predetermined product based on a plurality of pieces of information provided by a plurality of participants includes: a need reception unit which receives, from a need provider who provides need information indicating that it is desired to manufacture the predetermined product, the need information; a design information reception unit which discloses the need information and which receives each of one or more pieces of design information for manufacturing the predetermined product that is provided from each of a predetermined one or more participants among the participants;

a design optimization unit which optimizes the design for manufacturing the predetermined product based on the one or more pieces of design information received by the design information reception unit; a component information reception unit which receives information on each of a plurality of components of the predetermined product manufactured, based on the details of the design optimized by the design optimization unit, by each of a predetermined one or more participants among the participants; and a flow progress control unit which performs control on the flow of processing of the need reception unit, the design information reception unit, the design optimization unit and the component information reception unit, respectively.

In order to achieve the above object, as an information processing device according to one aspect of the present invention, an information processing device which manufactures and sells a predetermined product based on a plurality of pieces of information provided by a plurality of participants includes: a need reception unit which receives, from a need provider who provides need information indicating that it is desired to manufacture the predetermined product, the need information; a design information reception unit which discloses the need information and which receives each of one or more pieces of design information for manufacturing the predetermined product that is provided from each of a predetermined one or more participants among the participants; a design optimization unit which optimizes the design for manufacturing the predetermined product based on the one or more pieces of design information received by the design information reception unit; a component information reception unit which receives information on each of a plurality of components of the predetermined product manufactured, based on the details of the design optimized by the design optimization unit, by each of a predetermined one or more participants among the participants; a flow progress control unit which performs control on the flow of processing of the need reception unit, the design information reception unit, the design optimization unit and the component information reception unit, respectively; a feedback information acquisition unit which acquires feedback information from the need reception unit, the design information reception unit, the design optimization unit and the component information reception unit, respectively; and an evaluation reception unit which provides the feedback information acquired by the feedback information acquisition unit to the need provider so as to receive an evaluation by the need provider.

### Effects of the Invention

According to the present invention, it is possible to provide a method in which an aggregation of a plurality of users develops one product in cooperation, and in which thus it is possible to easily perform product development, financing, the acquisition of a manufacturing plant, the acquisition of a component vendor, the acquisition of a sales channel and the like that have so far required a large amount of time and cost.

### BRIEF DESCRIPTION OF THE DRAWINGS

FIG. 1 is a diagram showing an example of the configuration of an information processing system according to an embodiment of the present invention;

FIG. 2 is a diagram showing an outline of product development through a cloud utilizing services provided in a WEB portal to which the information processing system of FIG. 1 is applied;

FIG. 3 is a diagram showing an outline of product development with an SNS (SOCIAL NETWORKING SERVICE) utilizing the services provided in the WEB portal to which the information processing system of FIG. 1 is applied;

FIG. 4 is a diagram showing an outline of a product development project utilizing the services provided in the WEB portal to which the information processing system of FIG. 1 is applied;

FIG. 5 is a diagram showing an outline of a product development E market utilizing the services provided in the WEB portal to which the information processing system of FIG. 1 is applied;

FIG. 6 is a block diagram showing an outline of the flow of processing in a server which manages the WEB portal;

FIG. 7 is a block diagram showing the hardware configuration of the server of FIG. 1;

FIG. 8 is a functional block diagram showing an example of the functional configuration of the server of FIG. 7;

FIG. 9 is a flowchart illustrating a series of processing from when the server of FIG. 8 acquires the design information of a product until the completion of the product; and

FIG. 10 is a flowchart illustrating a series of processing from when the server 1 of FIG. 8 acquires generated feedback information until the evaluation of the product by a president is acquired as evaluation information.

### PREFERRED MODE FOR CARRYING OUT THE INVENTION

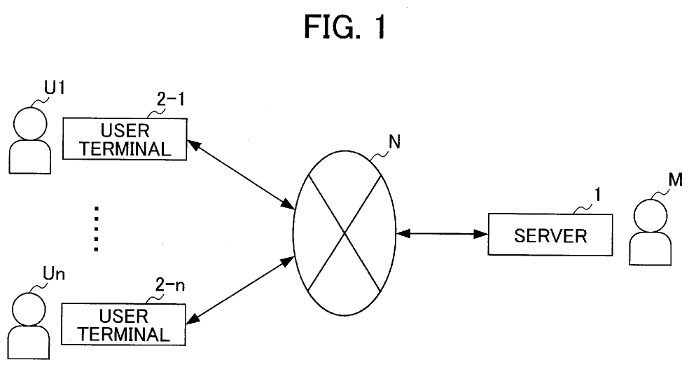

An embodiment of the present invention will be described below with reference to drawings. FIG. 1 is a diagram showing an example of the configuration of an information processing system according to one embodiment of the present invention.

The information processing system shown in FIG. 1 is formed so as to include a server 1 which is managed by a system administrator M and user terminals 2-1 to 2-n which are respectively operated by users U1 to Un (n is an arbitrary integer value equal to or more than 1). The server 1 and each of the user terminals 2-1 to 2-n are connected to each other through a predetermined network N such as the Internet. In the following description, when it is not necessary to individually distinguish the users U1 to Un, they are collectively referred to as “users U”. When they are referred to as the “users U”, the user terminals 2-1 to 2-n are also collectively referred to as “user terminals 2”.

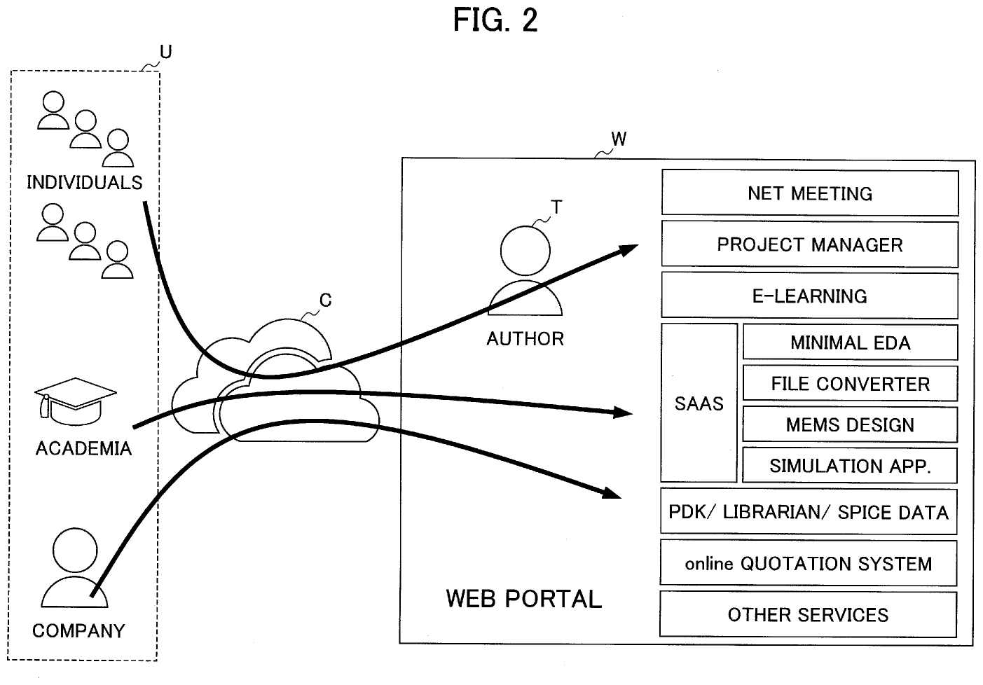

The system administrator M is the operating entity of a WEB portal established by the information processing system of FIG. 1. The WEB portal can manage the design, manufacturing, assembly and sale of a predetermined product, and consequently can supervise a series of flows from the development of the predetermined product to its sale. In other words, the users U get involved in, as users of the WEB portal, at least one of the design, manufacturing, assembly and sale of the predetermined product. The users U include not only individuals but also academic organizations such as universities, and companies. The details of specific services in the WEB portal operated by the system administrator M will be described with reference to FIG. 2 and the subsequent figures.

FIG. 2 is a diagram showing an outline of product development through a cloud C among the services provided in the WEB portal W to which the information processing system of FIG. 1 is applied.

As shown in FIG. 2, a person who performs management from the development of the predetermined product to its sale is hereinafter referred to as an “author T”. A person dispatched from the operating entity of the WEB portal is often put in charge of the author T but as necessary, a predetermined user among the users U may be put in charge thereof. The users U who utilize the WEB portal W include, as described above, individuals, academic organizations (academia) such as universities and companies. However, the users U are not limited to these, and include any organizations, groups and the like who may get involved in the development of the predetermined product. For example, an investor who wants to invest in the development of the predetermined product and the like can be included in the users U. The WEB portal W operated by the system administrator M provides, through the cloud C, for example, the following services to the users U described above.

Specifically, the users U can utilize, through the WEB portal W, services such as “NET MEETING”, “PROJECT MANAGER”, “E-LEARNING”, “SAAS (SOFTWARE AS A SERVICE)”, “PDK (PROCESS DESIGN KIT)”, “LIBRALIAN”, “SPICE (SIMULATION PROGRAM WITH INTEGRATED CIRCUIT EMPHASIS) DATA” and “ONLINE QUOTATION SYSTEM”.

Specifically, “NET MEETING” is a site where meetings are held, for example, between a plurality of users U and between the users U and the system administrator M, and is a site where not only chat by text but also communication using sounds, moving images and the like can be performed. “NET MEETING” is provided through the predetermined network N such as the Internet. For example, in the development of the predetermined product, a large number of users U who get involved in the development utilize “NET MEETING” and thus it is possible to reflect opinions of the large number of users U in various positions.

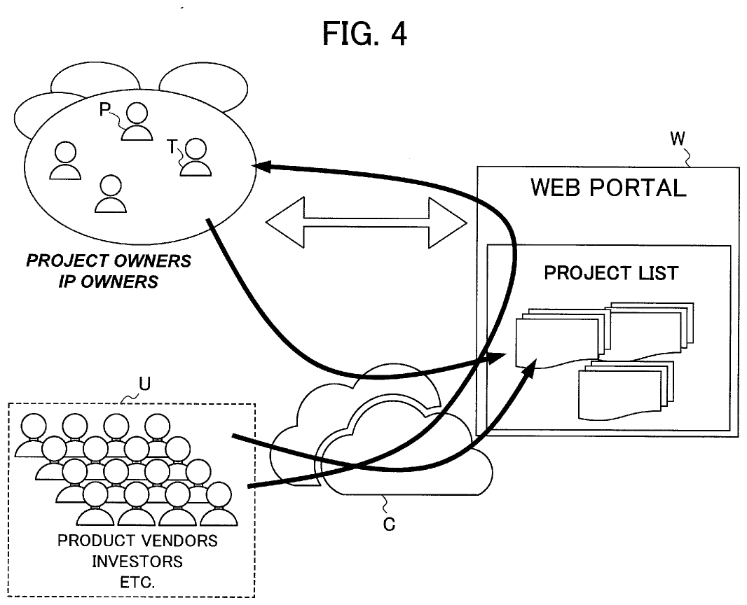

“PROJECT MANAGER” refers to a service which supports, among the users U, a user who is in a comprehensive responsible position in a project for manufacturing the predetermined product. In the development of the predetermined product, the user U utilizes “PROJECT MANAGER”, and thereby can launch a development project of the desired product. The users U in any positions can participate in the launched development project as members. The details of “PROJECT MANAGER” will be described later with reference to FIG. 4.

“E-LEARNING” refers to a service which provides, to the users U, a site where the users U perform various types of learning through the predetermined network N such as the Internet. The users U utilize “E-LEARNING” in the development of the predetermined product, and thereby can easily teach knowledge necessary for the development of the product. Hence, the knowledge level of the entire users U who utilize the WEB portal W is enhanced, and thus the quality and performance of the developed product are also enhanced.

“SAAS” refers to a service which makes the users U utilize only the necessary part of the necessary function in the development of the predetermined product. “SAAS” includes specific services such as “MINIMAL EDA (MINIMAL ELECTRONIC DESIGN AUTOMATION)”, “FILE CONVERTER”, “MEMS (MICRO ELECTRO MECHANICAL SYSTEMS) DESIGN” and “SIMULATION APP (APPLICATION SOFTWARE)”. For example, “MINIMAL EDA” refers to a service which supports the automation of an operation of designing a product such as a micro device on an extremely small scale. “FILE CONVERTER” refers to a service which converts a file format. “MEMS DESIGN” refers to a service which supports the design of a MEMS which is a micro device where various functions such as electronic, mechanical and optical functions are integrated. “SIMULATION APP” refers to a service which performs a simulation related to the manufacturing of various types of products. The users U utilize “SAAS” in the development of the predetermined product, and thereby can more smoothly perform the product development.

“PDK” is information which is necessary for the design of a product such as a micro device. “PDK” is collected and stored in the WEB portal W, and is provided to the users U as necessary. “LIBRALIAN” refers to a service which manages related information and resources for the project for developing the predetermined product. “SPICE DATA” is information in which the result of a simulation of the analog operation of an electronic circuit is collected and stored. “SPICE DATA” is collected and stored in the WEB portal W, and is provided to the user U as necessary. The users U utilize, in the development of the predetermined product, the services such as “PDK”, “LIBRALIAN” and “SPICE DATA”, and can thereby make full use of various types of data for the product development.

“ONLINE QUOTATION SYSTEM” refers to a service which makes an estimate online. The users U utilize, in the development of the predetermined product, “ONLINE QUOTATION SYSTEM”, and thereby can smoothly perform transactions with the other users U.

“OTHER SERVICES” are the other services. In other words, the users U utilize the WEB portal W, and can thereby receive not only the various types of services described above but also various services and the like for supporting the users U.

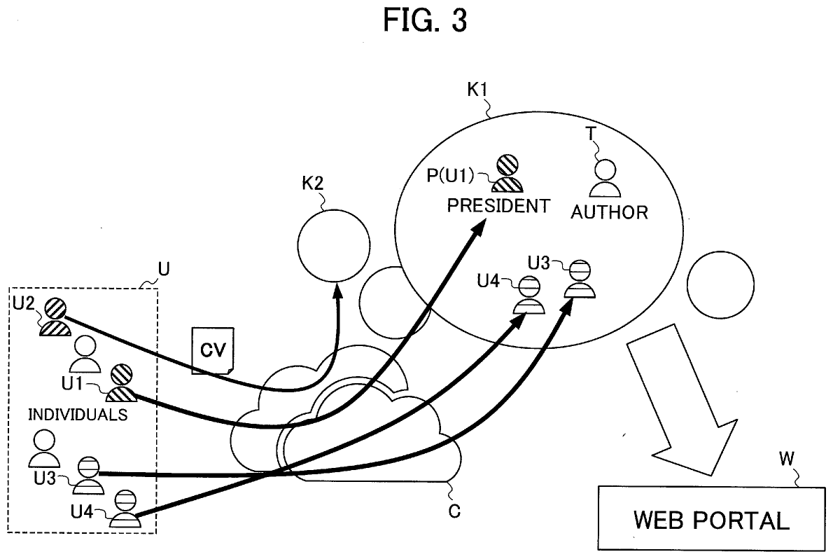

As described above, the users U utilize, in a combined manner, the various types of services described above provided in the WEB portal W, and thereby can realize the development of the desired product. An example of a case where the various types of services and the like provided in the WEB portal W are utilized in a combined manner will be described below with reference to FIGS. 3 to 6. When the users U and the like utilize the various types of services and the like provided in the WEB portal W, and thereby perform various types of operations and the like, the users U and the like operate their own user terminals 2 and the like. However, for ease of description, the processing of the user terminals 2 is omitted, and a description will be given from the standpoint of the users U who utilize the various types of services and the like provided in the WEB portal W.

FIG. 3 is a diagram showing an outline of product development with an SNS by utilization of the services and the like provided in the WEB portal W to which the information processing system of FIG. 1 is applied.

As shown in FIG. 3, for example, when a user U1 wants to develop a product A, the user U1 can establish a company K1 which develops the product A and become a president P of the company K1. Companies such as the company K1 established on the WEB portal W may be formed for convenience so as to be virtual ones. In this case, the system administrator M allocates to the company K1 a developer (hereinafter referred to as the “author T”) who is in charge of the development of the product A.

The user U can not only establish the company K1 on the WEB portal W on his or her own but also participate in an existing company K2 without establishing the company K1 on his or her own as shown in FIG. 3. For example, in the example of FIG. 3, when a user U2 wants to participate in the company K2, the user U2 transmits a resume CV of the user U2 to the company K2. In this way, the user U2 can participate in the company K2 as a member. As shown in FIG. 2, a user U3 and a user U4 participate in the company K1 as members. However, the user U2 who participates in the company K2 needs to receive permission from at least one of the author T and the president P in the company K2. At that time, the user U can previously register skills and the like, and thus the president P can also determine, from the details of the registration, whether or not to give the permission.

Here, in the specifications of the WEB portal W, the system administrator M can prevent the users U who participate in the company K1 as members from downloading information on the design for manufacturing the product A until the completion of the product A. In this way, it is possible to prevent unnecessary leakage of the information on the design. The president P can appoint another member who participates in the company K1 to be his or her successor. In this way, it is possible to make the company K1 survive in the long term. When all the members who participate in the company K1 agree, it is possible to liquidate the company K1. In this way, it is possible to prevent the company K1 from being liquidated due to the personal circumstances of the president P, and thus it is possible to stabilize the positions of the members who participate the company K1. The system administrator M can hold a predetermined percentage of intellectual property rights such as patents on the product developed in the company K1. In this way, it is possible to protect the benefits of the system administrator M who contributes to the development. All the members who participate in the company K1 can be enabled to utilize all the services provided in the WEB portal W. In this way, an aggregation of a plurality of users U can develop one product in cooperation, and thus it is possible to easily perform product development, financing, the acquisition of a manufacturing plant, the acquisition of a component vendor, the acquisition of a sales channel and the like that have so far required a large amount of time and cost.

FIG. 4 is a diagram showing an outline of a product development project utilizing the services provided in the WEB portal W to which the information processing system of FIG. 1 is applied.

As shown in FIG. 4, for example, when the product A is developed, the president P or the author T of the company K1 or a person who holds an intellectual property right on the product A announces in the WEB portal W that he or she wants to develop the product A. In this way, a project for developing the product A (hereinafter, a “product A development project”) with the president P or the author T of the company K1 being the project owner is started. The product A development project is listed in a project list which is managed in the WEB portal W. The users U who utilize the WEB portal W can browse various types of projects listed in the project list. In this way, some of the users U who browse the project list may offer to serve as users U (for example, various types of vendors) who want to develop the product A or users U (for example, individual investors) who want to invest in the development of the product A.

The users U who want to develop the product A include a user U who wants to make a design for the product A by utilization of his or her own specialty and a user U who wants to provide a component used in the product A. The project owner invites the users U who want to make a design for the product A to provide design details (ideas). In this way, the users U who want to make a design for the product A propose the design details for manufacturing the product A. Specifically, one or more users U who actually generate the design details for the product A upload one or more pieces of design information for establishing the design details through the WEB portal W to the project list for the project owner.

When a plurality of pieces of design information are provided by one or more users U who want to make a design for the product A, in the WEB portal W, the design necessary for manufacturing the product A is optimized. In the optimization of the design, consideration is given to priorities based on individual abilities (for example, productivity, scale and technical capabilities) of the members who participate in the product A development project, the amount of money which is invested in the product A development project and the like. Here, the optimization of the design is a broad concept which includes the generation of a new piece of design information that is optimal for the manufacturing of the product A based on a plurality of pieces of design information from one or more users U and the selection of one or more pieces of design information that are optimal for the manufacturing of the product A from the plurality of pieces of design information. Furthermore, the processing of one or more pieces of design information selected such as the improvement of one or more pieces of design information selected, the addition of a predetermined item and the combination of one or more pieces of design information selected can also be included in the optimization. Furthermore, the selection of the user U who makes a design for the product A and the selection of the user U who allocates parts of the design can also be included in the optimization of the design. In the present embodiment, the president P and the author T do not make a design.

When the design necessary for manufacturing the product A is optimized, the manufacturing of the product A is started based on the details of the optimized design (such as various types of design information). In this case, the project owner selects, from the users U who want to provide a component necessary for manufacturing the product A, the user U who is actually put in charge of the manufacturing of the component. When the project owner selects the user U who is actually put in charge of the manufacturing of the component, the project owner can reference the optimized design information in the WEB portal W. The users U include a user who wants to assemble components so as to complete the product A. Hence, the project owner selects, from the users U, the user who is put in charge of the assembly for assembling the components and thereby completing the product A. When the component is manufactured by the user U who is in charge of the manufacturing of the component of the product A, information on the component is uploaded to the project list through the WEB portal W. Then, the components are assembled by the user U who is in charge of the assembly, and thus the product A is completed. The completed product A is uploaded to the project list through the WEB portal W.

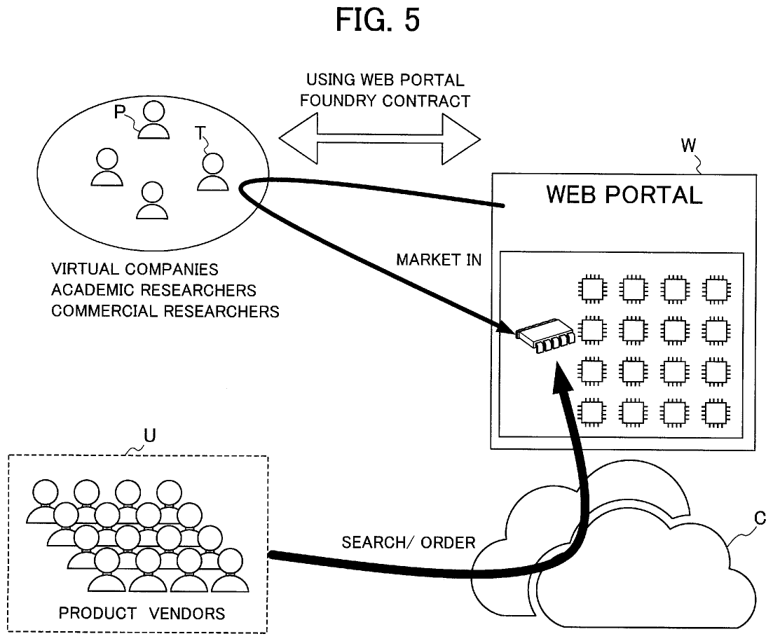

FIG. 5 is a diagram showing an outline of a product development E market utilizing the services provided in the WEB portal W to which the information processing system of FIG. 1 is applied.

As shown in FIG. 5, the president P of the company K1 who is the project owner can sell the product A manufactured in the product A development project based on a foundry contract with the system administrator M by utilization of an E market among the services of the WEB portal W. The entity of the foundry contract is not limited to the president P of the company K1, and may be an academic researcher or a commercial researcher among the users U who participate in the company K1.

The users U who utilize the WEB portal W can utilize the E market among the services of the WEB portal W. Hence, when the product A is sold in the E market, the users U who utilize the E market can search for the product A and place an order. Here, when the product A is, for example, a micro device, there can be a vendor who wants to incorporate the product A in the manufacturing of his or her own product among the users U.

As described above, among a plurality of users U, an aggregation of a user who announces they want to develop the product A, a user who announces they want to invest in the development of the product A, a user who announces they want to design the product A and a user who announces they want to provide a component of the product A completes the product A. Then, among a plurality of users U, a user who announces they want to purchase the product A purchases the product A. In other words, based on a need (for example, a need for wanting to develop the product A) provided by one or a small number of users U, a large number of users offer to support the need, so that this provides power obtained by utilization of their respective specialties. For example, the funding, design, manufacturing, assembly and marketing are provided. In this way, all the series of flows from the development of the product A to its sale can be performed on the WEB portal W operated by the system administrator M. In other words, it is possible to easily perform product development, financing, the acquisition of a manufacturing plant, the acquisition of a component vendor, the acquisition of a sales channel and the like that have so far required a large amount of time and cost.

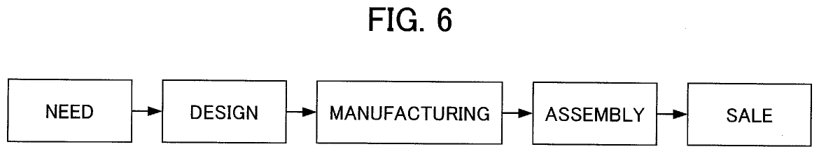

FIG. 6 is a block diagram showing an outline of the flow of processing in the server 1 which manages the WEB portal W described with reference to FIGS. 1 to 5.

As shown in FIG. 6, the various types of services which are described with reference to FIGS. 1 to 5 and which are provided by the WEB portal W can be realized by performing, in the server 1, five types of processing, that is, the need”, “design”, “manufacturing”, “assembly” and “sale”. In the flow of the series of processing performed by the server 1, the “need” refers to processing in which when the user U in the WEB portal W announces they want to develop the product A, the server 1 receives information on the need of the user U. Specifically, when the user U who operates the user terminal 2 announces, on the WEB portal W, that the product A development project is established, the server 1 receives the specific details of the announcement as the information on the need.

In the flow of the series of processing performed by the server 1, the “design” refers to various types of processing including supporting the user U who performs designing with the user terminal 2 and storing information when the user U who utilizes the WEB portal W announces they want to design the product A in reply to the information on the need disclosed on the WEB portal W. Specifically, when the user U who operates the user terminal 2 uploads the design information on the product A onto the WEB portal W, the server 1 receives the design information. Furthermore, the server 1 performs, based on the design information, optimization processing on the design details necessary for manufacturing the product A. In the optimization processing on the design details by the server 1, consideration is given to any reference information which is stored and managed in the server 1 and which ranges from the development of the product to its sale. For example, the server 1 may generate, as the optimization processing, based on a plurality of pieces of design information of one or more users U, a new piece of design information which is optimal for the manufacturing of the product A. For example, the server 1 may select, as the optimization processing, among the pieces of design information, one or more pieces of design information which are optimal for the manufacturing of the product A. Furthermore, for example, the server 1 may perform, as at least part of the optimization processing, the processing of one or more pieces of design information selected such as the improvement of one or more pieces of design information selected, the addition of a predetermined item and the combination of one or more pieces of design information selected. Furthermore, the server 1 can perform, as necessary, as the optimization processing, the selection of the user U who makes a design for the product A and the selection of the user U who allocates parts of the design.

In the flow of the series of processing performed by the server 1, the “manufacturing” refers to various types of processing in which when the user U who utilizes the WEB portal W announces they want to manufacture a component of the product A, the user U who manufactures the component of the product A is selected and in which the manufacturing of the component of the product A is supported. Specifically, the server 1 provides information for supporting the selection of the user U who is in charge of the manufacturing of the component of the product A. When the user U who operates the user terminal 2 uploads information on the component of the product A manufactured by the user U to the project list on the WEB portal W, the server 1 receives the information.

In the flow of the series of processing performed by the server 1, the “assembly” refers to various types of processing including selecting a user U who assembles the components when the user U who utilizes the WEB portal W announces he or she wants to assemble the components in order to complete the product A, the various types of processing further including supporting the assembling of the components for the manufacturing of the product A. Specifically, for example, when a semiconductor is adopted as the product A, after the preceding step of the semiconductor, for example, processing for attaching a lead frame to form a package is performed as the assembly. When the lead frame is attached to form the package, processing for supporting the user U is also performed as the assembly. When processing for providing information for supporting the selection of the user U who is in charge of the assembly of the components of the product A is performed or the user U who operates the user terminal 2 uploads information on the product A assembled by the user U to the project list on the WEB portal W, processing for receiving the information is also performed as at least part of the assembly.

In the flow of the series of processing performed by the server 1, the “sale” refers to processing in which in the E market among the services provided by the WEB portal W, the sale and purchase of the product A between the users U is managed.

The server 1 also produces feedback information in each of the five types of processing, that is, the need”, “design”, “manufacturing”, “assembly” and “sale”. Here, the “feedback information” refers to information on the history of the details of the specific processing, information on a problem occurring in the processing, information on a solution when the problem is solved and the like. The produced feedback information is provided through the WEB portal W to the president P who is the project owner of the product A development project. The president P evaluates the product A developed by the product A development project based on the feedback information acquired through the WEB portal W. The evaluation of the product A by the president P is stored as evaluation information and is utilized for the processing of a design optimization unit 103 in the subsequent steps. Depending on the type of product A, the “assembly” and “sale” may be omitted as necessary.

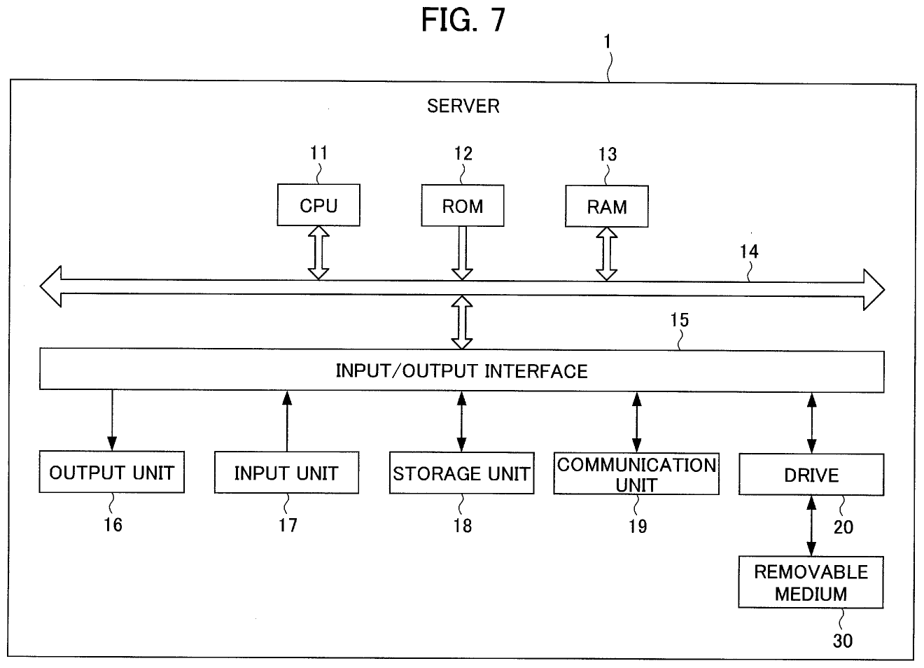

Next, the hardware configuration of the server 1 in the information processing system of FIG. 1 will be described. FIG. 7 is a block diagram showing the hardware configuration of the server of FIG. 1.

The server 1 includes a CPU (Central Processing Unit) 11, a ROM (Read Only Memory) 12, a RAM (Random Access Memory) 13, a bus 14, an input/output interface 15, an output unit 16, an input unit 17, a storage unit 18, a communication unit 19 and a drive 20.

The CPU 11 performs various types of processing according to a program recorded in the ROM 12 or a program loaded from the storage unit 18 to the RAM 13. In the RAM 13, data and the like which are necessary for the CPU 11 to perform various types of processing are also stored as necessary.

The CPU 11, the ROM 12 and the RAM 13 are connected to each other through the bus 14. The input/output interface 15 is also connected to the bus 14. The output unit 16, the input unit 17, the storage unit 18, the communication unit 19 and the drive 20 are connected to the input/output interface 15.

The output unit 16 is formed with a display, a speaker and the like, and outputs various types of information as images and sounds. The input unit 17 is formed with a keyboard, a mouse and the like, and inputs various types of information.

The storage unit 18 is formed with a hard disk and a DRAM (Dynamic Random Access Memory) and the like, and stores various types of data. The communication unit 19 performs communication with other devices (in the example of FIG. 1, the user terminals 2-1 to 2-n) through the network N including the Internet.

A removable medium 30 which is formed with a magnetic disk, an optical disk, a magneto-optical disk, a semiconductor memory or the like is fitted to the drive 20 as necessary. A program read by the drive 20 from the removable medium 30 is installed into the storage unit 18 as necessary. The removable medium 30 can also store the various types of data stored in the storage unit 18 as with the storage unit 18.

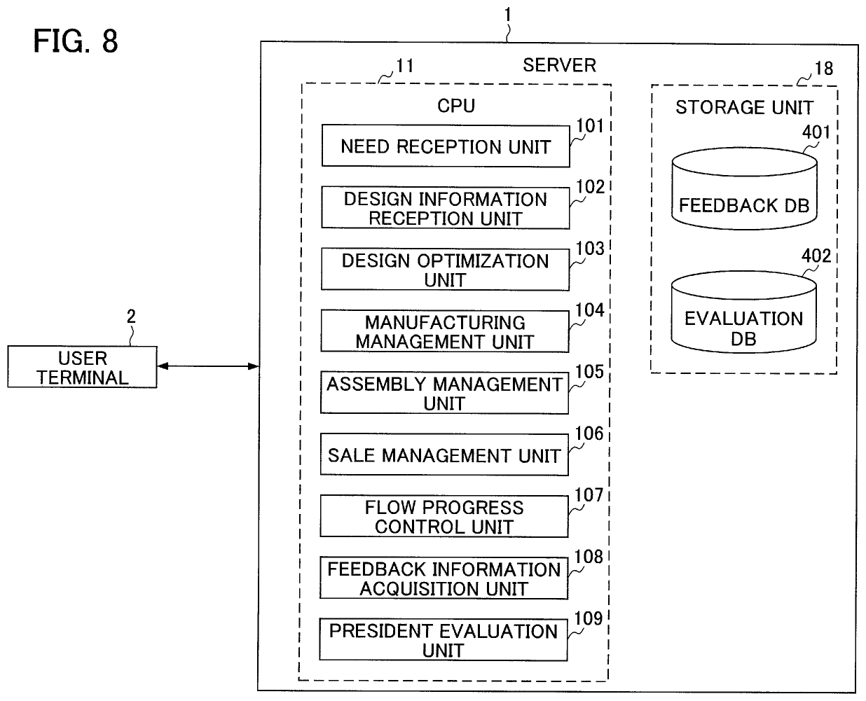

Next, the details of various types of processing performed by the server 1 of FIG. 7 will be described. FIG. 8 is a functional block diagram showing an example of the functional configuration of the server 1 of FIG. 7.

In the CPU 11 of the server 1, a need reception unit 101, a design information reception unit 102, a design optimization unit 103, a manufacturing management unit 104, an assembly management unit 105, a sale management unit 106, a flow progress control unit 107, a feedback information acquisition unit 108 and a president evaluation unit 109 function. In one region of the storage unit 18, a feedback DB 401 and an evaluation DB 402 are provided.

The need reception unit 101 receives, as need information, from a need provider who desires to manufacture the predetermined product, information indicating that the there is a need for the development of the predetermined product. Here, as the need information, information is adopted which indicates, when the user U announces, on the WEB portal W, they want to manufacture the predetermined product, the specific details of the announcement. The need provider refers to, among the users U, a user who provides the need information on the WEB portal W, and applies to, for example, the president P or the like. For example, when the user U operates the user terminal 2 to announce that on the WEB portal W, the product A development project is established, the need reception unit 101 receives information based on the announcement as the need information. The need reception unit 101 generates information indicating the details of the specific processing performed by itself. This information is so-called history information, and is information which needs to be fed back, and hence it is hereinafter referred to as “feedback information”.

The design information reception unit 102 discloses, on the Web portal W, the need information received by the need reception unit 101. In other words, a plurality of participants can recognize the need information through the Web portal W. The design information reception unit 102 receives, as design information, respective information for designing the predetermined product provided from each of a predetermined one or more participants among the participants. Here, a “participant” refers to a user who announces, on the WEB portal W, they shall participate in the manufacturing and sale of the product related to the received need information. For example, in a case where the product A is manufactured as the predetermined product, when the user U operates the user terminal 2 to upload the design information on the product A on the WEB portal W, the design information reception unit 102 receives the design information. The design information reception unit 102 generates feedback information indicating the details of the specific processing performed by itself.

The design optimization unit 103 optimizes the design details of the predetermined product based on one or more pieces of design information received by the design information reception unit 102. Here, the “design details” refer to information of a design drawing, a specific manufacturing method and the like which is necessary for manufacturing the predetermined product. For example, in a case where the product A is manufactured as the predetermined product, the design optimization unit 103 optimizes the design details of the product A based on the received design information. The design optimization unit 103 generates feedback information indicating the details of the specific processing performed by itself.

The manufacturing management unit 104 receives information on each of a plurality of components of the predetermined product which are manufactured by each of a predetermined one or more participants among the participants based on the design details optimized by the design optimization unit 103. For example, in a case where the product A is manufactured as the predetermined product, the manufacturing management unit 104 receives, when information on the components of the product A manufactured by the predetermined user U is uploaded on the WEB portal W, the information on the components. The manufacturing management unit 104 generates feedback information indicating the details of the specific processing performed by itself. In this way, the manufacturing management unit 104 manages the manufacturing of the components of the product A.

The assembly management unit 105 receives, when the components received by the manufacturing management unit 104 are assembled, information on the predetermined product which is the completed product. For example, in a case where the product A is manufactured as the predetermined product, the assembly management unit 105 receives, when the user U operates the user terminal 2 to upload information on the product A assembled by the user U on the WEB portal W, the information on the assembly. The assembly management unit 105 generates feedback information indicating the details of the specific processing performed by itself. In this way, the assembly management unit 105 manages the assembly of the components for completing the product A.

The sale management unit 106 manages the sale of the completed predetermined product. Here, the “sale” refers to the sale of the predetermined product by utilization of the E market among the services of the WEB portal W. For example, in a case where the product A is completed as the predetermined product, the sale management unit 106 manages the sales and purchase of the product A between the users U in the E market among the services provided by the WEB portal W. The sale management unit 106 generates feedback information indicating the details of the specific processing performed by itself.

The flow progress control unit 107 controls the progress of the flow of the processing of the need reception unit 101, the design information reception unit 102, the design optimization unit 103, the manufacturing management unit 104, the assembly management unit 105 and the sale management unit 106, respectively. The server 1 has the configuration described above, and thus an aggregation of a plurality of users develops one product in cooperation, with the result that it is possible to easily perform product development, financing, the acquisition of a manufacturing plant, the acquisition of a component vendor, the acquisition of a sales channel and the like that have so far required a large amount of time and cost.

The feedback information acquisition unit 108 acquires the feedback information generated in the processing of the need reception unit 101, the design information reception unit 102, the design optimization unit 103, the manufacturing management unit 104, the assembly management unit 105 and the sale management unit 106, respectively. The feedback information acquired by the feedback information acquisition unit 108 is stored in the feedback DB 401.

The president evaluation unit 109 provides the feedback information acquired by the feedback information acquisition unit 108 to the user terminal 2 operated by the president P. Then, the president evaluation unit 109 acquires, when the product A is evaluated through the WEB portal W based on the feedback information, information on the evaluation as the evaluation information. The evaluation information acquired by the president evaluation unit 109 is stored in the evaluation DB 402. In this way, the president P can evaluate not only the completed product A but also the product based on the feedback information in the individual stages from the design of the product A to its sale.

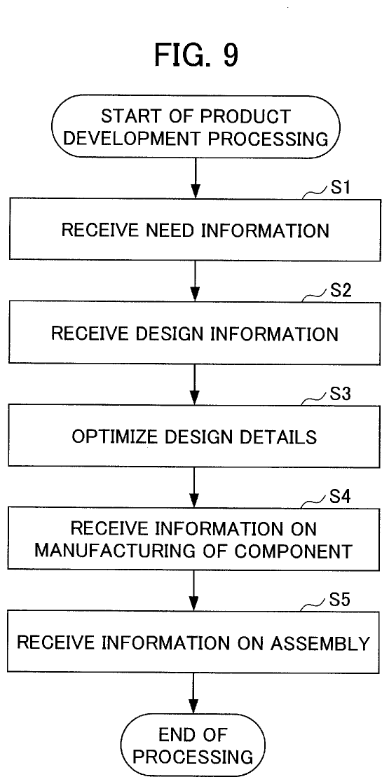

Next, an example of the processing performed by the server 1 having the functional configuration described with reference to FIG. 8 will be described with reference to the flowchart of FIG. 9.

FIG. 9 is the flowchart illustrating a series of processing (hereinafter referred to as “product development processing”) from when the server 1 having the functional configuration described with reference to FIG. 8 acquires the design information of the product A until the completion of the product A.

In step S1, when the user U who operates the user terminal 2 announces, on the WEB portal W, that the product A development project is established, the need reception unit 101 receives the specific details of the announcement as the need information. In step S2, when the user U who operates the user terminal 2 uploads the design information to the project list on the WEB portal W, the design information reception unit 102 receives this design information. In step S3, the design optimization unit 103 performs, based on the design information received in step S2, the optimization processing on the design details necessary for manufacturing the product A by the user U. In step S4, when information on the component manufactured by the user U is uploaded to the WEB portal W by the user U who operates the user terminal 2, the manufacturing management unit 104 receives this information. In step S5, when the information on the product A assembled by the user U is uploaded to the project list on the WEB portal W by the user U who operates the user terminal 2, the assembly management unit 105 receives this information. In this way, the product development processing is completed.

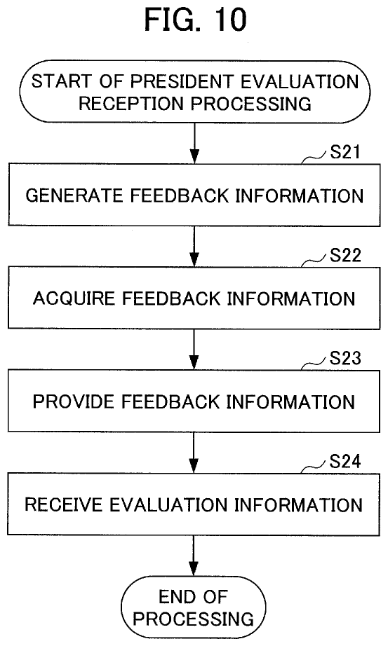

Next, another example of the processing performed by the server 1 having the functional configuration of FIG. 8 will be described with reference to the flowchart of FIG. 10.

FIG. 10 is the flowchart illustrating a series of processing (hereinafter referred to as “president evaluation reception processing”) from when the server 1 of FIG. 8 acquires the feedback information generated in the respective processing of the individual stages until the evaluation of the product A by the president P is acquired as the evaluation information.

In step S21, each of the need reception unit 101, the design optimization unit 103, the manufacturing management unit 104, the assembly management unit 105 and the sale management unit 106 individually perform the processing, and thereafter generate the feedback information. In step S22, the feedback information acquisition unit 108 acquires the feedback information generated in step S21. In step S23, the president evaluation unit 109 provides the feedback information acquired by the feedback information acquisition unit 108 in step S22 to the user terminal 2 operated by the user U who is the president P. In step S24, when the evaluation of the product A based on the feedback information is performed by the president P who is the user U operating the user terminal 2, the president evaluation unit 109 receives information on the evaluation of the product A as the evaluation information of the product A. In this way, the president evaluation reception processing is completed.

Although the embodiment of the present invention is described above, the present invention is not limited to the embodiment described above, and variations, modifications and the like performed in such a range that the object of the present invention can be achieved are included in the present invention.

For example, although in the embodiment described above, the WEB portal W (FIG. 2) which is mainly optimal for manufacturing a semiconductor is adopted, there is no particular limitation on this configuration, and thus by applying the present invention it is possible to provide the WEB portal which is optimal for order receiving/placing in any product. In other words, as the product to which the present invention is applied, for example, a micro device which includes the semiconductor described above can be adopted. Here, the “micro device” includes any extremely small-sized electronic device such as semiconductor components, various types of sensors, MEMS (Micro Electro Mechanical Systems), medical electronic devices and DNA computers. Moreover, for example, as the product to which the present invention is applied, for example, a robot can be adopted. In this case, in order to assemble the robot, Pass (registered trademark) (platform as a service) and Saas (registered trademark) (software as a service) for robots can be included in the WEB portal. Moreover, for example, mechanism analysis tools such as AutoCAD and Adams (registered trademark), structure analysis software such as MSC (registered trademark), various types of simulation tools, 3D printers and the like can be included. Moreover, for example, in addition to products, an integrated framework of ideas and various types of software produced by academia such as PTCs and universities can be included in the WEB portal. Such software is used by a large number of users U and the like, and bugs are corrected, with the result that the software becomes a more sophisticated software or the like.

For example, the hardware configuration shown in FIG. 7 is simply illustrative in order to achieve the object of the present invention and is not particularly limited.

The functional block diagram shown in FIG. 8 is simply illustrative and is not particularly limited. In other words, as long as the information processing device has the function of performing the series of processing described above as a whole, what types of functional blocks are used to realize this function is not particularly limited to the example of FIG. 8.

The places where the functional blocks are present are also not limited to FIG. 8, and any places may be adopted. One functional block may be formed with only hardware, may be formed with only software or may be formed with a combination thereof.

When the processing of the functional blocks is performed with software, programs forming the software are installed from a network or a recording medium into a computer or the like. The computer may be a computer which is incorporated in dedicated hardware. The computer may be a computer which can perform various types of functions by installing various types of programs such as a server, a general-purpose smartphone or a personal computer.

For example, the recording medium including the programs described above is formed with a removable medium which is distributed separately from the main body of the device in order to provide the programs to each user or is formed with a recording medium which is provided to each user in a state where the recording medium is previously incorporated in the main body of the device.

In the present specification, a step of writing the programs to be recorded in the recording medium includes not only processing which is performed chronologically according to the order thereof but also processing which is not always performed chronologically and which is performed in parallel or individually. For example, in FIG. 9, in the flow of the product development processing, after all the feedback information including the feedback information generated by the need reception unit 101 is generated, the feedback information acquisition unit 108 acquires all the feedback information. However, all the feedback information may be obtained in the stage before the evaluation by the president P is performed. Hence, the feedback information acquisition unit 108 may acquire various types of feedback information, in the stage before the evaluation by the president P is performed even if it is not after all the feedback information has been generated, at any time or at the same time.

In the present specification, the term of the system means an overall device which is formed with a plurality of devices, a plurality of means and the like.

Hence, the information processing device (for example, the server 1 of FIG. 1) to which the present invention is applied preferably has the following configuration and can have various types of embodiments. Specifically, as the information processing device to which the present invention is applied, an information processing device which performs support processing for manufacturing a predetermined product based on a plurality of pieces of information provided by a plurality of participants includes: a need reception unit (for example, the need reception unit 101 of FIG. 8) which receives, from a need provider who provides information on a need for manufacturing the predetermined product, as need information, the information; a design information reception unit (for example, the design information reception unit 102 of FIG. 8) which discloses the need information and which receives, as design information, respective information for designing the predetermined product that is provided from each of a predetermined one or more participants among the participants; a design optimization unit (for example, the design optimization unit 103 of FIG. 8) which optimizes the design of the predetermined product based on one or more pieces of the design information; a component information reception unit (for example, the manufacturing management unit 104 of FIG. 8) which receives information on each of a plurality of components of the predetermined product manufactured based on the details of the optimized design by each of a predetermined one or more participants among the participants; and a flow progress control unit (for example, the flow progress control unit 107 of FIG. 8) which controls the progress of the flow of processing of the need reception unit, the design information reception unit, the design optimization unit and the component information reception unit, respectively. In this way, an aggregation of a plurality of users develops one product in cooperation, with the result that it is possible to easily perform product development, financing, the acquisition of a manufacturing plant, the acquisition of a component vendor, the acquisition of a sales channel and the like that have so far required a large amount of time and cost.

The information processing device (for example, the server 1 of FIG. 1) to which the present invention is applied, is an information processing device which performs support processing for manufacturing a predetermined product based on a plurality of pieces of information provided by a plurality of participants includes: need reception unit (for example, the need reception unit 101 of FIG. 8) which receives, from a need provider who provides information on a need for manufacturing the predetermined product, as need information, the information; a design information reception unit (for example, the design information reception unit 102 of FIG. 8) which discloses the need information and which receives, as design information, respective information for designing the predetermined product that is provided from each of a predetermined one or more participants among the participants; a design optimization unit (for example, the design optimization unit 103 of FIG. 8) which optimizes the design of the predetermined product based on one or more pieces of the design information; a component information reception unit (for example, the manufacturing management unit 104 of FIG. 8) which receives information on each of a plurality of components of the predetermined product manufactured based on the details of the optimized design by each of a predetermined one or more participants among the participants; a feedback information acquisition unit (for example, the feedback information acquisition unit 108 of FIG. 8) which acquires feedback information from the need reception unit, the design information reception unit, the design optimization unit and the component information reception unit, respectively; and an evaluation reception unit (for example, the president evaluation unit 109 of FIG. 8) which provides the feedback information on the need reception unit, the design information reception unit, the design optimization unit and the component information reception unit, respectively, to the need provider so as to receive an evaluation by the need provider. In this way, it is possible to evaluate not only the completed product but also the product based on the feedback information in the individual stages from the design of the product to its sale.

### EXPLANATION OF REFERENCE NUMERALS

1: server
2, 2-1, 2-n: user terminal
11: CPU
12: ROM
13: RAM
14: bus
15: input/output interface
16: output unit
17: input unit
18: storage unit
19: communication unit
20: drive
30: removal medium
101: need reception unit
102: design information reception unit
103: design optimization unit
104: manufacturing management unit
105: assembly management unit
106: sale management unit
107: flow progress control unit
108: feedback information acquisition unit
109: president evaluation unit
401: feedback DB
402: evaluation DB
C: cloud
K, K1, K2: company
M: system administrator
N: network
U, U1, U2, U3, U4: user
W: WEB portal

1. An information processing device which performs support processing for manufacturing a predetermined product based on a plurality of pieces of information provided by a plurality of participants, the information processing device comprising:
a need reception unit which receives, from a need provider who desires to manufacture the predetermined product, as need information, information indicating that there is a need for a development of the predetermined product;
a design information reception unit which discloses the need information and which receives, as design information, respective information for designing the predetermined product that is provided from each of a predetermined one or more participants among the participants;
a design optimization unit which optimizes a design of the predetermined product based on one or more pieces of the design information;
a component information reception unit which receives information on each of a plurality of components of the predetermined product manufactured based on details of the optimized design by each of a predetermined one or more participants among the participants; and
a flow progress control unit which controls progress of a flow of processing of the need reception unit, the design information reception unit, the design optimization unit and the component information reception unit, respectively.

2. An information processing device which performs support processing for manufacturing a predetermined product based on a plurality of pieces of information provided by a plurality of participants, the information processing device comprising:
a need reception unit which receives, from a need provider who desires to manufacture the predetermined product, as need information, information indicating that there is a need for a development of the predetermined product;
a design information reception unit which discloses the need information and which receives, as design information, respective information for designing the predetermined product that is provided from each of a predetermined one or more participants among the participants;
a design optimization unit which optimizes a design of the predetermined product based on one or more pieces of the design information;
a component information reception unit which receives information on each of a plurality of components of the predetermined product manufactured based on details of the optimized design by each of a predetermined one or more participants among the participants;
a feedback information acquisition unit which acquires feedback information from the need reception unit, the design information reception unit, the design optimization unit and the component information reception unit, respectively; and
an evaluation reception unit which provides feedback information on the need reception unit, the design information reception unit, the design optimization unit and the component information reception unit, respectively, to the need provider so as to receive an evaluation by the need provider.
